(19) United States
(12) Patent Application Publication
(10) Pub. No.: US 2017/0174194 A1
(43) Pub. Date: Jun. 22, 2017

(54) METHOD FOR OPERATING A VEHICLE

(71) Applicant: Robert Bosch GmbH, Stuttgart (DE)

(72) Inventors: Rainer Baumgaertner, Pfaffenhofen (DE); Jeannine Schwarzkopf, Ludwigsburg (DE); Florian Hauler, Linkenheim (DE)

(21) Appl. No.: 15/116,059

(22) PCT Filed: Dec. 2, 2014
(86) PCT No.: PCT/EP2014/076305

§ 371 Date: Aug. 2, 2016

(30) Foreign Application Priority Data
Feb. 3, 2014 (DE) 10 2014 201 822.6

(51) Int. Cl. B60T 8/1755; B60T 8/92; B60T 8/1761

(52) U.S. Cl. CPC B60T 8/17552; B60T 8/17616; B60T 8/92; B60T 2201/16; B60T 2230/02; B60T 2270/402

(57) ABSTRACT

A method for operating a vehicle, a braking device, including a parking brake as one element and a brake booster as another element for actuating a service brake of the vehicle, being actuated to decelerate the vehicle, so that a braking force, which decelerates the vehicle, is generated with the aid of the braking device, during deceleration of the vehicle, at least one of the elements of the baking device being controlled in such a way that the generated braking force varies over time. A control device for a braking device of a vehicle, a braking system for a vehicle, and a computer program, are also described.

### FIELD

The present invention relates to a method for operating a vehicle. The present invention also relates to a control device for a parking brake of a vehicle, a braking system and a computer program.

### BACKGROUND INFORMATION

Vehicles generally have a service brake and a parking brake, which is independent of the service brake, as well as usually having a brake booster. Vehicles generally also have an anti-lock braking system, which is also known in German road traffic regulations as an automatic anti-lock system. In the event of a failure of the anti-lock system, there may be a risk during a brake application that the problem of an overbraked rear axle and generally a loss of track guidance of the vehicle may occur. The vehicle may then lose a longitudinal stabilization and be at risk of swerving. This may increase the risk of a side impact with a tail end of a traffic jam, obstacles or other vehicles.

Therefore, there is a need for decelerating a vehicle, for example, in the event of a failure of an anti-lock system, for example an anti-lock braking system, or an ESP (electronic stability program), whereby the risk of a side impact with an obstacle is reduced.

### SUMMARY

An object of the present invention is to provide a method for operating a vehicle, which overcomes the above disadvantages and reduces the risk of a side impact with an obstacle.

An object of the present invention is also to provide a corresponding control device for a braking device of a vehicle.

An object of the present invention is also to provide a corresponding braking system for a vehicle.

An object of the present invention is also to provide a corresponding computer program.

According to one aspect of the present invention, a method for operating a vehicle is provided, wherein a braking device is actuated, which includes a parking brake as one element and a brake booster as another element for actuating a service brake of the vehicle, so that a braking force, which decelerates the vehicle, is generated with the aid of the braking device, at least one of the elements of the braking device (i.e., either only the parking brake or only the brake booster or both the brake booster and the parking brake) being controlled during the deceleration of the vehicle, in such a way that the generated braking force is varied over time.

According to one additional aspect, a control device for a braking device of a vehicle is provided, the control device being configured to carry out the method for operating a vehicle.

According to yet another aspect, a braking system for a vehicle is provided, the braking system including a braking device which has a parking brake as one element and a brake booster as another element for actuating a service brake of the vehicle and a control device for the braking device.

According to yet another aspect, a computer program is provided, including program code for carrying out the method for operating a vehicle when the computer program is carried out in a computer, in particular in a control device.

The present invention thus includes actuating or controlling the parking brake and/or the brake booster during the deceleration of the vehicle with the aid of the braking device in such a way that the braking force generated with the aid of the parking brake and/or with the aid of the service brake is varied, i.e., modulated, over time. In another words, this means in particular that a braking effect of the parking brake and/or the service brake is varied, i.e., modulated, over time. The braking effect of the parking brake and/or of the service brake thus changes over time. This advantageously counteracts locking of a wheel, which is being braked or decelerated by the braking device. Swerving and/or skidding of the vehicle may be advantageously reduced or prevented. This may advantageously ensure better steerability and better directional stability of the vehicle. Therefore, the risk of a side impact of the vehicle with an obstacle may be advantageously reduced or prevented.

This means in particular that the parking brake is being controlled during the deceleration, in such a way that the braking force generated by the parking brake is varied, i.e., modulated, over time.

This means in particular that the brake booster is controlled during the deceleration in such a way that the brake booster is actuated in accordance with the service brake, in such a way that the braking force generated by the service brake is varied, i.e., modulated, over time.

It is thus possible to provide in particular that only the parking brake is used for decelerating the vehicle with corresponding modulation over time of the generated braking force. It is thus possible in particular to provide that the service brake is actuated only by corresponding control of the brake booster, in such a way that the braking force generated by the service brake is varied over time. It is thus possible to provide in particular that both the parking brake and the brake booster are used for deceleration, with variation, i.e., modulation, over time according to the present invention.

The parking brake generates a braking force directly, i.e., immediately. The brake booster generates a braking force indirectly, i.e., not immediately with the aid of the service brake. The braking device may thus include the service brake in particular.

In particular, a redundancy with respect to a conventional anti-lock braking system, which may possibly be present in the vehicle, is thus advantageously made available. Thus, even if there is a failure of the anti-lock braking system, an anti-lock function is still available via modulation of the parking brake. Even if the service brake of the vehicle should fail, an effective and efficient brake function or braking effect is still available by variation or modulation or change in the parking brake over time, which is capable of effectively minimizing or even preventing swerving or skidding of the vehicle, as is the case with a conventional anti-lock braking system.

The stabilization function achieved according to the present invention is preferably used in failure situations, for example, in the event of failure of an anti-lock braking system. The present invention should thus usually meet the minimum statutory requirements in such failure situations. The present invention at least facilitates the compliance with such minimum statutory requirements or makes a substantial contribution to the compliance and thus the severity of the hazard, for example, may be reduced to an acceptable degree or even prevented entirely.

An automatic anti-lock system within the meaning of the present invention is a generic term used for conventional systems, which prevent locking of one or multiple vehicle wheel(s). Such systems are known as anti-lock braking systems (ABS), electronic stability programs (ESP) or traction control systems (ASR), for example. The term “automatic anti-lock system” originates from German road traffic regulations. Those skilled in the art are also familiar with the term ESP via the abbreviation ESC (electronic stability control).

The present invention makes it possible, for example, to advantageously dispense with a redundant second anti-lock braking system (or an additional redundant automatic anti-lock system in general when an ABS system is mentioned below, this should be understood to refer to an automatic anti-lock system). Such a second system is generally expensive and technically difficult to implement. In particular, in a redundant second anti-lock braking system, two to four additional wheel speed sensors would be necessary. In particular, in the case of a redundant second anti-lock braking system, additional brake calipers would be necessary.

The present invention thus makes it possible to reduce costs and to save on the expense of technical implementation for a redundant second anti-lock braking system.

The parking brake within the meaning of the present invention denotes in particular a brake, which is configured to permanently lock the vehicle when stopped. Another term for the parking brake is in particular the term “hand brake.” The parking brake functions independently of the service brake of the vehicle. This means in particular that the parking brake is able to brake the vehicle independently of the service brake. The parking brake acts in particular on one or multiple wheel(s) of the vehicle, thereby braking them.

According to one specific embodiment, it may be provided that the parking brake is electronically actuatable. To this extent, the parking brake is preferably designed as an electronic parking brake.

The service brake of the vehicle is in particular configured to decelerate or brake the vehicle during operation of the vehicle, i.e., in particular while the vehicle is being operated.

According to one specific embodiment, the vehicle includes a parking brake and a service brake, each being configured and functioning independently of the other.

Within the meaning of the present invention, the brake booster is configured in particular to boost a driver's intended braking in a suitable manner, so that the intended braking effect is achieved. The brake booster may be designed, for example, as an active vacuum booster, as an electronic or hydraulic brake booster. Robert Bosch refers to such an active vacuum booster as an “iBooster.” The brake booster generally acts preferably on all wheels of the vehicle, in particular on all four wheels. In particular the brake booster may also act on only one brake circuit, for example, on the front axle brake circuit or the rear axle brake circuit. Multiple brake boosters may preferably be provided.

According to one specific embodiment, it may be provided that an actual longitudinal acceleration of the vehicle is measured during the deceleration of the vehicle with the aid of the parking brake, whereby the generated braking force is varied over time as a function of the measured actual longitudinal acceleration, in such a way that the actual longitudinal acceleration of the vehicle is within a defined setpoint longitudinal acceleration range to prevent a vehicle wheel from locking.

This advantageously makes it possible to prevent a vehicle wheel from locking. This is the case in particular with a vehicle wheel, which is being decelerated or braked with the aid of the parking brake. In particular, the parking brake may brake or decelerate multiple vehicle wheels. In particular, the parking brake may brake or decelerate all wheels of the vehicle. In the case of one vehicle wheel, it may be a rear wheel of the vehicle, for example. When using an ABS system, the service brake generally brakes the individual wheels on an individual basis.

The setpoint longitudinal acceleration range may be defined empirically (for example, based on an average road surface and/or weather conditions). A friction coefficient estimate is preferably used to define the setpoint longitudinal acceleration range. For example, the last estimate of the friction coefficient of the ESP or ABS before failure may be used. For example, a friction coefficient estimate may be carried out with the aid of a rain sensor and/or an outside temperature sensor and/or traffic information and/or digital road maps in conjunction with GPS. Alternatively or additionally, a onetime or cyclical partial test brake application may be carried out. For example, a braking torque may be increased and decreased once or cyclically until an increase or decrease, respectively, of the deceleration is detected via an inertial sensor system (i.e., one or multiple inertial sensors). Thus, for example, it is possible to maximize the braking torque. Conversely, the maximum longitudinal deceleration may be determined in this way, whereby it must only be ensured that an empirical distance from the maximum is maintained.

According to one specific embodiment, the actual longitudinal acceleration is measured with the aid of an inertial sensor, in particular an acceleration sensor. In particular, a plurality of inertial sensors, in particular multiple acceleration sensors, may be provided for this purpose. The inertial sensors may be, for example, the same or preferably different.

According to another specific embodiment, it may be provided that, during the deceleration of the vehicle with the aid of the parking brake, an actual yaw rate of the vehicle is measured and the generated braking force is varied over time, as a function of the measured actual yaw rate, in such a way that the actual yaw rate of the vehicle is within a defined setpoint yaw rate range to prevent skidding of the vehicle.

Skidding of the vehicle is thus advantageously prevented.

The yaw rate changes are thus monitored in particular, and the braking torque is reduced as a function of this monitoring (i.e., the generated braking force is reduced) to prevent skidding during brake application or deceleration. It is preferably possible to additionally or alternatively provide that a steering intervention is requested from the driver. Alternatively or additionally, in another specific embodiment, it may be provided that an automatic or automated steering intervention is carried out, i.e., a steering assistance in particular, because it is usually difficult here to include the driver since generally very short reaction times are involved. Due to the automatic or automated steering intervention, it is thus possible to react within a shorter period of time than a driver's usual reaction time.

Power steering of the vehicle (for example, an EPS “electronic power steering”) preferably delivers one or multiple steering torques, executing such steering torques in particular in addition to the driver's intended steering. The power steering is therefore controlled accordingly, for example. In an automatic or automated steering intervention, it is preferably possible to provide that the steering angle is set or predefined independently of the driver.

The change in yaw rate should be sufficiently small during the brake application. With additional availability of the driver's intended steering, the deviation from the setpoint yaw rate may be calculated and limited. For example, the driver's intended steering is ascertained by a steering angle sensor (the driver's intended steering is usually supplied via CAN (controller area network) in vehicles including ESP). The actual threshold value for the deviation must be kept as small as possible, which depends on the specific individual case, in particular on the ambient conditions and/or the vehicle. Those skilled in the art are capable of ascertaining suitable threshold values for the specific individual case. A signal accuracy and/or estimation errors is/are preferably taken into account here; these values are normally not equal to zero.

According to one specific embodiment, it may be provided that the yaw rate is measured with the aid of an inertial sensor, in particular with the aid of a yaw rate sensor. In particular, multiple inertial sensors, preferably multiple yaw rate sensors, may be provided for this purpose. The inertial sensors may be, for example, the same or preferably different.

According to another specific embodiment, it may be provided that, when the measured actual yaw rate is greater than a defined yaw rate threshold value, automatic counter-steering takes place with the aid of a steering of the vehicle to reduce the actual yaw rate of the vehicle below the defined yaw rate threshold value. In other words, this means in particular that counter-steering is automatically carried out against the actual yaw rate with the aid of the steering of the vehicle.

In other words, this means in particular that, in addition to the variation or modulation over time, there is active counter-steering, so that skidding may be reduced even more effectively, or if skidding of the vehicle has already occurred, the vehicle may be guided into a safe state.

According to another specific embodiment, it may be provided that, during the deceleration of the vehicle with the aid of the parking brake, an actual transverse acceleration of the vehicle is measured, the generated braking force being varied over time as a function of the measured actual transverse acceleration, in such a way that the actual transverse acceleration of the vehicle is within a defined setpoint transverse acceleration range to prevent skidding and/or swerving of the vehicle.

Therefore, skidding or swerving of the vehicle is advantageously preventable.

The setpoint transverse acceleration range may be ascertained or defined similarly to the setpoint longitudinal acceleration range. The appropriate statements are applicable similarly.

According to one specific embodiment, it may be provided that the transverse acceleration is measured with the aid of an inertial sensor, in particular with the aid of an acceleration sensor. For example, multiple inertial sensors, preferably multiple acceleration sensors, may be used for this purpose. The inertial sensors may be, for example, the same or preferably different.

In one specific embodiment, it may be provided that the control device is configured to control the steering of the vehicle. This is the case in particular when a measured actual yaw rate of the vehicle is greater than a defined yaw rate threshold value. This is the case in particular for counter-steering of the vehicle against the yaw according to the yaw rate of the vehicle.

In another specific embodiment, it may be provided that the at least one element of the braking device is controlled during deceleration only in such a way that the generated braking force is varied over time when a failure of an automatic anti-lock system, for example, an ABS or an ESP of the vehicle, is detected, because such an anti-lock system should normally result in a longitudinal stabilization of the vehicle. However, if the anti-lock system fails, then its functionality is effectuated according to the present invention with the aid of a corresponding control of the parking brake and/or the brake booster. Thus, even in the event of a failure of an anti-lock system, longitudinal stabilization of the vehicle is achievable, which may increase vehicle safety.

The present invention is explained in greater detail below on the basis of preferred exemplary embodiments.

### BRIEF DESCRIPTION OF THE DRAWINGS

FIG. 1 shows a flow chart of a method for operating a vehicle.

FIG. 2 shows a flow chart of another method for operating a vehicle.

FIG. 3 shows a flow chart of another method for operating a vehicle.

FIG. 4 shows a control device.

FIG. 5 shows a braking system for a vehicle.

FIG. 6 shows a vehicle.

### DETAILED DESCRIPTION OF EXAMPLE EMBODIMENTS

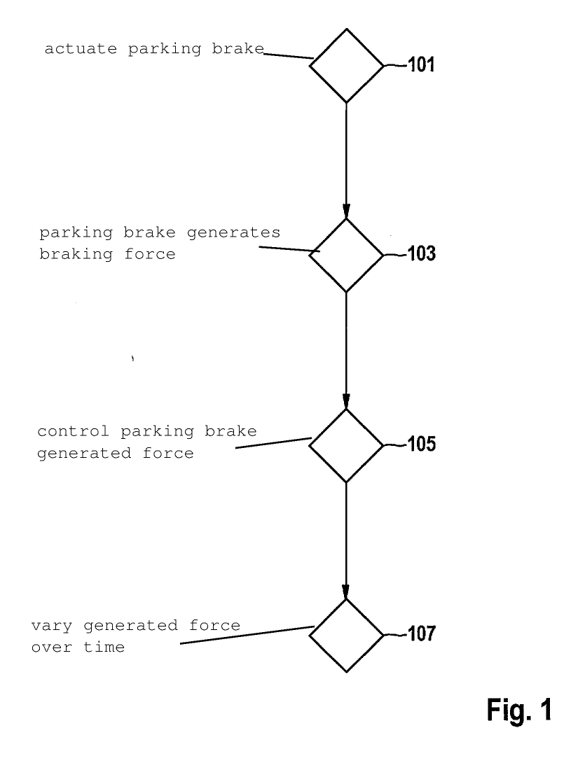

FIG. 1 shows a flow chart of a method for operating a vehicle.

According to a step 101, a parking brake of the vehicle is actuated as an element of a braking device to decelerate or brake the vehicle. In a step 103, the actuated parking brake generates a braking force. The braking force acts in particular on one wheel or preferably on multiple wheels of the vehicle. In a step 105, the parking brake is controlled during the deceleration of the vehicle with the aid of the parking brake, i.e., while the parking brake is actuated, in such a way that the generated braking force is varied, i.e., modulated, over time in a step 107.

Due to the variation or modulation over time, locking of the wheels of the vehicle is advantageously counteracted. Swerving or skidding of the vehicle may be advantageously reduced or prevented. In particular this achieves better steerability and better directional stability. Therefore, a risk of a side impact with an obstacle may be further reduced in an advantageous manner.

In addition, it is pointed out that a compromise has been made: the longitudinal guidance is improved, but the fact that the maximum possible deceleration is reduced, if necessary, is accepted. However, this is conclusive since a front impact generally has a lower risk potential with today's vehicles. Furthermore, this compromise is applicable only in the event of failure of the ABS or ESP for the service brake. The possible disadvantage (lower maximum possible deceleration) outweighs the advantage (improved longitudinal guidance).

In a specific embodiment not shown here, it may be provided that in step 101, instead of or in addition to actuation of the parking brake, a brake booster is actuated as an additional element of the braking device. The brake booster actuates a service brake of the vehicle, thereby generating a braking force, which decelerates the vehicle. It is provided that the brake booster is controlled in such a way that it actuates the service brake, so that the generated braking force is varied or modulated over time. These advantages are obtained in a manner similar to the preceding discussion in conjunction with the actuation of the parking brake.

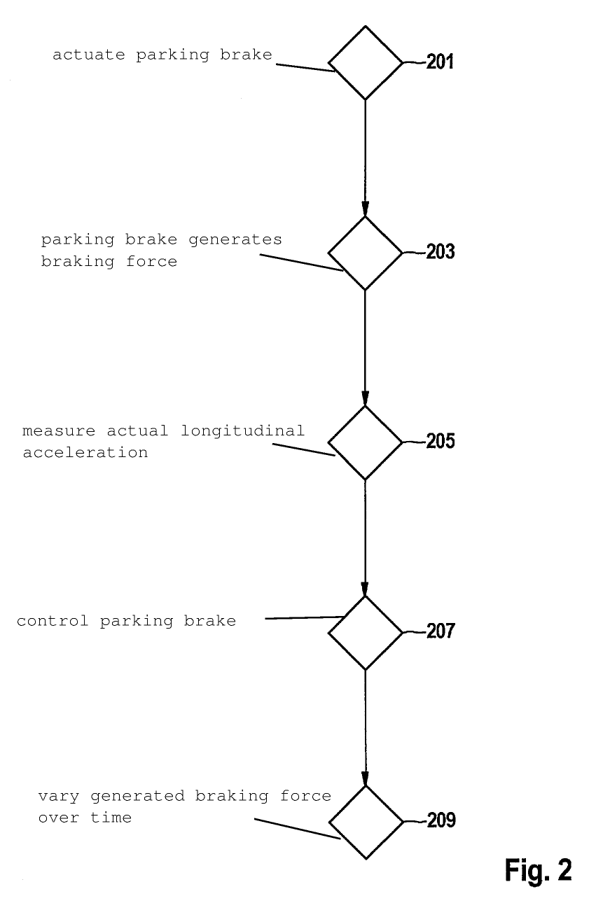

FIG. 2 shows a flow chart of another method for operating a vehicle.

According to a step 201, a parking brake is actuated for decelerating the vehicle. The actuated parking brake generates a braking force, which decelerates the vehicle according to a step 203. According to a step 205, an actual longitudinal acceleration of the vehicle is measured during the deceleration of the vehicle with the aid of the parking brake. In a step 207, the parking brake is controlled during the deceleration of the vehicle with the aid of the parking brake in such a way that, according to a step 209, the generated braking force is varied over time. This variation over time is carried out here as a function of the measured actual longitudinal acceleration. This is the case in particular, in that the actual longitudinal acceleration of the vehicle is within a defined setpoint longitudinal acceleration range to prevent a vehicle wheel from locking or to again release a locked vehicle wheel.

Thus, for example, the generated braking force generated is reduced when the measured actual longitudinal acceleration is greater than an upper limit of the setpoint longitudinal acceleration range, because a deceleration of the vehicle is generally so great that one or multiple wheels are locked. Inasmuch as the generated braking force is reduced in this case, the braking effect is advantageously also reduced, which in turn advantageously results in the actual longitudinal acceleration of the vehicle being reduced.

For example, if the measured actual longitudinal acceleration is below a lower limit of the setpoint longitudinal acceleration range, then the generated brake force is increased until the actual longitudinal acceleration of the vehicle is again within the setpoint longitudinal acceleration range. This advantageously increases a braking force, which increases the braking effect. Therefore, an actual longitudinal acceleration of the vehicle is advantageously increased or elevated. The braking distance of the vehicle may thus be shortened advantageously.

The preceding discussions in conjunction with FIG. 2 are applicable similarly if the longitudinal acceleration is replaced or supplemented by the yaw rate and/or the transverse acceleration. In addition, the preceding discussion is also applicable in conjunction with FIG. 2 similarly for the case when the brake booster is actuated in addition to or instead of the actuation of the parking brake, so that the booster actuates the service brake of the vehicle, the brake booster being controlled in a manner similar to that in FIG. 1, in such a way that it actuates the service brake so that the generated braking force is varied or modulated over time. The advantages are obtained in conjunction with the actuation of the parking brake in a manner similar to that in the preceding discussions.

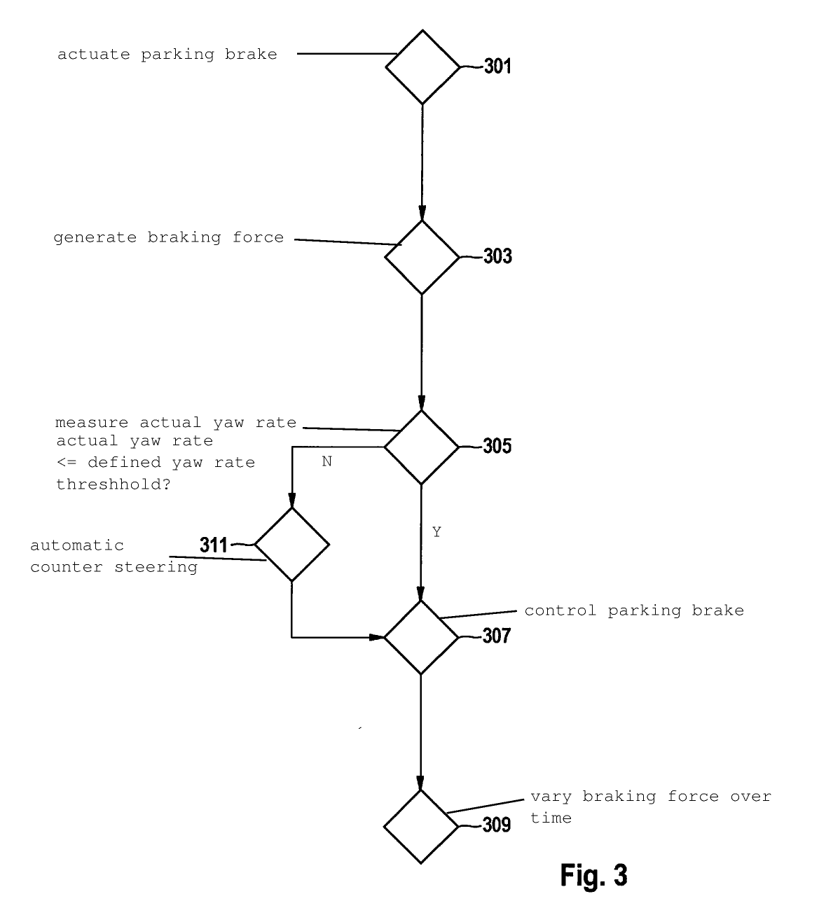

FIG. 3 shows a flow chart of another method for operating a vehicle.

According to a step 301, a parking brake is actuated to decelerate the vehicle, which generates a braking force, which decelerates the vehicle according to a step 303. In a step 305, an actual yaw rate of the vehicle is measured during the deceleration of the vehicle with the aid of the parking brake. In a step 307, the parking brake is controlled during the deceleration of the vehicle, in such a way that the generated braking force is varied over time according to a step 309. This variation is carried out in particular as a function of the measured actual yaw rate.

In addition, in step 305, a test step is also provided, in which it is checked whether the measured actual yaw rate is less than or equal to a defined yaw rate threshold value. If the measured actual yaw rate is greater than a defined yaw rate threshold value, then automatic counter-steering of the vehicle takes place with the aid of the steering of the vehicle in a step 311 to reduce the actual yaw rate of the vehicle below the defined yaw rate threshold value. In other words, this means in particular that counter-steering takes place in such a way that the actual yaw rate of the vehicle is reduced. This means in particular that automatic counter-steering takes place automatically against the actual yaw rate with the aid of the steering of the vehicle.

Steps 307 and 309 may be carried out simultaneously with step 311, for example. Steps 307 and 309 may be carried out in particular only after step 311, in particular after the counter-steering has ended.

If it is found in test step 305 that the measured actual yaw rate is less than or equal to the defined yaw rate threshold value, then step 311 is not carried out but instead only steps 307 and 309 are carried out.

The preceding discussions in conjunction with FIG. 3 also apply similarly for the case when the brake booster is actuated in addition to or instead of actuation of the parking brake, so that the booster actuates the service brake of the vehicle, whereby the brake booster is controlled similarly to FIG. 1 or 2, so that it actuates the service brake in such a way that the generated braking force is varied or modulated over time. Similar to the preceding discussions, the advantages are derived in conjunction with the actuation of the parking brake.

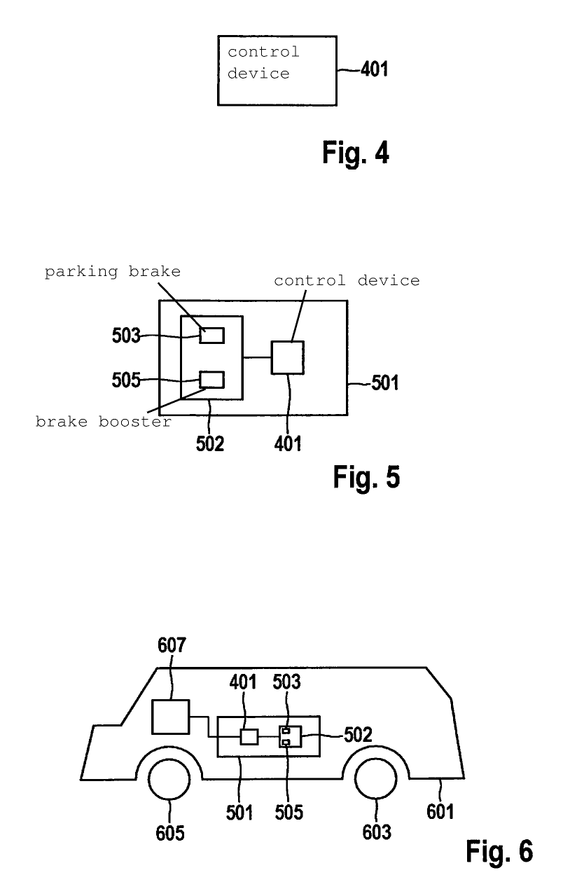

FIG. 4 shows a control device 401 for a braking device of a vehicle.

Control device 401 is configured to carry out the method for operating a vehicle.

FIG. 5 shows a braking system 501 for a vehicle.

Braking system 501 includes a braking device 502, which includes a parking brake 503 as one element and a brake booster 505 as another element for actuating a parking brake (not shown). Braking system 501 includes control device 401 according to FIG. 4, which is designed to control at least one of the elements of braking device 502 by the method according to the present invention.

In one specific embodiment, not shown here, it may be provided that braking system 501 includes the service brake, which is designed independently of parking brake 503 and functions and may be operated independently of the parking brake. The service brake and parking brake 503 supply a braking effect or braking force independently of one another.

FIG. 6 shows a vehicle 601.

Vehicle 601 includes braking system 501 according to FIG. 5. Parking brake 503 has a braking or decelerating effect on rear wheels 603 and/or front wheels 605 of vehicle 601. Parking brake 503 is therefore in corresponding operating connection with front wheels 605 and rear wheels 603.

A service brake (not shown here) of the vehicle may be actuated with the aid of brake booster 505, so that the service brake generates a braking force, which decelerates vehicle 601. The service brake here acts on rear wheels 603 and/or front wheels 605.

Vehicle 601 includes a sensor system 607 (which may also be referred to in general as a sensor device), which may include one or multiple inertial sensor(s). The inertial sensors may be in particular the same or preferably different. An inertial sensor may be, for example, an acceleration sensor (for example, a transverse acceleration sensor or a longitudinal acceleration sensor) or a yaw rate sensor. Acceleration of the vehicle, in particular a longitudinal and/or transverse acceleration may be measured advantageously with the aid of sensor system 607, which may be referred to in general as an inertial sensor system or as an inertial sensor device. In particular the yaw rate of the vehicle may be measured with the aid of inertial sensor system 607. Depending on the measured accelerations and/or yaw rates, the braking force generated with the aid of parking brake 503 is then varied or modulated over time.

In a specific embodiment, not shown here, it may be provided that control device 401 is configured to control a steering of the vehicle. This is the case in particular when a measured actual yaw rate of the vehicle is greater than a defined yaw rate threshold value. This is the case in particular for counter-steering of the vehicle against the yaw according to the yaw rate of the vehicle.

The present invention thus includes in particular modulating, i.e., varying, i.e., changing over time the braking effect of the parking brake or the service brake, which is actuated with the aid of the brake booster. This is preferably the case in the event of an ABS failure.

1-9. (canceled)

10. A method for operating a vehicle, comprising:
actuating a braking device, the braking device including a parking brake as one element and a brake booster as another element for actuating a service brake of the vehicle, the braking device being actuated to decelerate the vehicle, so that a braking force, which decelerates the vehicle, is generated by the braking device; and
while the vehicle is being decelerated, controlling at least one of the elements of the braking device in such a way that the generated braking force is varied over time.

11. The method as recited in claim 10, wherein, while the vehicle is being decelerated, an actual longitudinal acceleration of the vehicle is measured, and the generated braking force is varied over time depending on the measured actual longitudinal acceleration, in such a way that the actual longitudinal acceleration of the vehicle is within a defined setpoint longitudinal acceleration range to prevent a vehicle wheel from locking.

12. The method as recited in claim 10, wherein, while the vehicle is being decelerated, an actual yaw rate of the vehicle is measured, and the generated braking force is varied over time depending on the measured actual yaw rate, in such a way that the actual yaw rate of the vehicle is within a defined setpoint yaw rate range to prevent skidding of the vehicle.

13. The method as recited in claim 12, wherein when the measured actual yaw rate is greater than a defined yaw rate threshold value, automatic counter-steering takes place with the aid of a steering of the vehicle to reduce the actual yaw rate of the vehicle below the defined yaw rate threshold value.

14. The method as recited in claim 10, wherein, during the deceleration of the vehicle, an actual transverse acceleration of the vehicle is measured, and the generated braking force is varied over time depending on the measured actual transverse acceleration in such a way that the actual transverse acceleration of the vehicle is within a defined setpoint transverse acceleration range to prevent skidding of the vehicle.

15. The method as recited in claim 10, wherein the at least one element of the braking device is controlled during the deceleration only in such a way that the generated braking force is varied over time when a failure of an automatic anti-lock system of the vehicle is detected.

16. A control device for a braking device of a vehicle, the control device configured to:
actuate a braking device, the braking device including a parking brake as one element and a brake booster as another element for actuating a service brake of the vehicle, the braking device being actuated to decelerate the vehicle, so that a braking force, which decelerates the vehicle, is generated by the braking device; and
while the vehicle is being decelerated, control at least one of the elements of the braking device in such a way that the generated braking force is varied over time.

17. A braking system for a vehicle, comprising:
a braking device, which has a parking brake as one element and a brake booster as an additional element for actuation of a service brake of the vehicle; and
a control device control device for a braking device of a vehicle, the control device configured to actuate the braking device to decelerate the vehicle, so that a braking force, which decelerates the vehicle, is generated by the braking device, and while the vehicle is being decelerated, control at least one of the elements of the braking device in such a way that the generated braking force is varied over time.

18. A non-transitory computer readable storage medium storing a computer program including program code for operating a vehicle, the program code, when executed by a computer, causing the computer to perform:
actuating a braking device, the braking device including a parking brake as one element and a brake booster as another element for actuating a service brake of the vehicle, the braking device being actuated to decelerate the vehicle, so that a braking force, which decelerates the vehicle, is generated by the braking device; and
while the vehicle is being decelerated, controlling at least one of the elements of the braking device in such a way that the generated braking force is varied over time.
